(19) United States
(12) Patent Application Publication
(10) Pub. No.: US 2026/0234847 A1
(43) Pub. Date: Aug. 13, 2026

(54) NONWOVEN FABRIC WEB WITH OIL SENSITIVE, PARTICULATE ABSORBENT OF ORGANICS

(71) Applicants: John S. BRINKMAN, Welland (CA); Douglas B. BROWN, Fremont, WI (US)

(72) Inventors: John S. BRINKMAN, Welland (CA); Douglas B. BROWN, Fremont, WI (US)

(73) Assignee: IMBIBITIVE TECHNOLOGIES CORPORATION, Niagara Falls, NY (US)

(21) Appl. No.: 18/831,358

(22) PCT Filed: Jun. 7, 2023
(86) PCT No.: PCT/US2023/000023

§ 371 Date: Mar. 26, 2025

Related U.S. Application Data
(60) Provisional application No. 63/473,589, filed on Jun. 8, 2022.

(51) Int. Cl. D04H 1/407; D04H 1/4291; D04H 3/16

(52) U.S. Cl. CPC D04H 1/407; D04H 1/4291; D04H 3/16; D10B 2321/022; D10B 2509/026

(57) ABSTRACT

Article of manufacture for absorbing an organic chemical or organic chemical mixture includes a construction of a nonwoven fabric web with an oil sensitive particulate absorbent of the organic chemical or mixture. The nonwoven fabric web can be melt blown and/or spunbond product(s) or a hybrid meltblown-spunbond product. The oil sensitive, particulate absorbent can be provided as hydrophobic, water insoluble, particulate organic polymeric particles that, when contacted with a organic substance or mixture, absorb or imbibe it substantially thereupon. The oil sensitive absorbent particles may remain with the article essentially without sifting.

This claims priority benefits of provisional patent application No. U.S. 63/473,589 filed on Jun. 8, 2022 A.D. The specification of that application—to include the patent and patent application publication documents attached thereto and part thereof, and including disclosures in abstracts, written descriptions, claims and/or drawings as attached to the priority document—is incorporated herein by reference in its entirety, by operation of treaty, law or rule, or where also or otherwise is permitted such as in the United States of America, by the present notice and incorporation. Furthermore, not only are the specifications, including abstracts, written descriptions, claims and/or drawings, of each and every one of the patents and patent application publications identified as having been attached to the priority document, but also are the specifications, including abstracts, written descriptions, claims and/or drawings, of all of the patents and patent application publications cited or referenced herein, hereby incorporated by reference in their entireties, by operation of treaty, law or rule, or where also or otherwise is permitted such as in the United States of America, by the present notice and incorporation.

### FIELD AND PURVIEW OF THE INVENTION

Of concern is a nonwoven fabric web with, in general, an oil sensitive, particulate absorbent of organics. Advantageously, for instance, the fabric web can be a Spun-Blown® meltblown-spunbond product and the absorbent an oil sensitive, particulate, fluid-organic-swellable, water-insoluble polymer such as Imbiber Beads® particles disbursed into the fabric web at various weight per square unit distributions.

### BACKGROUND TO THE INVENTION

It has been said, “Necessity is the mother of invention.” Product improvement may be thought of as a necessity sought by the better practitioners in the field.

Brown et al., U.S. Pat. No. 10,633,774 B2, discloses a hybrid non-woven web and an apparatus and method for forming said web. It is disclosed that certain particulate fibers, particles or gels, desirably pulp materials, but also or in lieu of those, a “superabsorbent” in a form of fibers, particles or gels. The “superabsorbents,” generally speaking, are water sensitive, water swellable materials capable of absorbing at least about twenty times their weight in an aqueous solution containing 0.9 weight percent sodium chloride.

Brinkman et al., U.S. Pat. Nos. 11,103,851 B2 and 11,117,116 B2 disclose methods to use a construction that absorbs an organic chemical, and constructions that absorb an organic material. Among other beneficial things, these patents provide spill control products for organic spills, which can be applied more directly and efficiently than theretofore known, particularly where the amount of released target organic chemical is smaller in volume, thus providing a viable solution to an “over-capacity” issue where a standard product such as a blanket or boom containing Imbiber Beads® product, which may pick up and hold 12-16 L of organic liquid so as to be ideal to sequester significantly large spills, was employed in a spill only millimeters deep. Although ameliorated noticeably, a problem remained with an amount of particulate Imbiber Beads® product “sifting” from the matrix, which, among other things, would affect precisely how much absorptive capacity is available in the construction. As well, manufacture could be improved.

Note also, the following art, referenced by one or more of the aforementioned patents as well as the priority document:

U.S. Pat. No. 8,122,570 B2. This patent, referenced in U.S. Pat. No. 10,633,774 B2, discloses an apparatus and method for dry forming a uniform nonwoven fibrous web.

U.S. Pat. No. 4,100,324. This patent, referenced in U.S. Pat. No. 10,633,774 B2, discloses a nonwoven fabric and method of producing same.

U.S. Pat. No. 9,303,334 B2. This patent, referenced as application Ser. No. 14/271,638 in U.S. Pat. No. 10,633,774 B2, discloses an apparatus for forming a nonwoven web.

U.S. Pat. No. 9,309,612 B2. This patent, referenced as application Ser. No. 14/271,655 in U.S. Pat. No. 10,633,774 B2, discloses a process for forming a nonwoven web.

Patent Application Publication No. US 2015/0322602 A1. This publication, referenced as application Ser. No. 14/271,675 in U.S. Pat. No. 10,633,774 B2, discloses a nonwoven web.

U.S. Pat. No. 3,322,695. This patent, referenced in U.S. Pat. Nos. 11,103,851 B2 and 11,117,116 B2, discloses preparation of porous structures.

U.S. Pat. No. 3,750,688. This patent, referenced in U.S. Pat. Nos. 11,103,851 B2 and 11,117,116 B2, discloses a valve and method for aqueous systems.

U.S. Pat. No. 4,302,337. This patent, referenced in U.S. Pat. Nos. 11,103,851 B2and 11,117,116 B2, discloses separation of oil from water.

U.S. Pat. No. 2,795,564. This patent, referenced in U.S. Pat. No. 4,302,337, discloses aqueous paint bases and water-base paints and process for preparing them.

U.S. Pat. No. 2,914,499. This patent, referenced in U.S. Pat. No. 4,302,337, discloses emulsion polymerization with acrylic-type acid esters of hydroxysulfonic acids and compositions therefrom.

U.S. Pat. No. 3,062,765. This patent, referenced in U.S. Pat. No. 4,302,337, discloses emulsion polymerization of water insoluble ethylenic monomers.

U.S. Pat. No. 3,177,173. This patent, referenced in U.S. Pat. No. 4,302,337, discloses aqueous latexes of heat-curable elastomers containing carboxylic acid groups.

U.S. Pat. No. 3,404,116. This patent, referenced in U.S. Pat. No. 4,302,337, discloses latices of butadiene copolymers with monomers having hydroxyl and carboxyl groups.

U.S. Pat. No. 3,480,578. This patent, referenced in U.S. Pat. No. 4,302,337, discloses preparation of carboxylic polymers in acid aqueous media.

U.S. Pat. No. 3,882,230. This patent, referenced in U.S. Pat. No. 4,302,337, discloses substituted benzoic acid hypolipemic agents.

U.S. Pat. No. 7,169,318 B1. This patent, referenced in U.S. Pat. Nos. 11,103,851 B2 and 11,117,116 B2, discloses imbibed organic liquids, especially halogenated organics.

U.S. Pat. No. 7,704,750 B2. This patent, referenced in U.S. Pat. Nos. 11,103,851 B2 and 11,117,116 B2, discloses a visual spill indicator.

U.S. Pat. No. 7,862,779 B2. This patent, referenced in U.S. Pat. Nos. 11,103,851 B2 and 11,117,116 B2, discloses visual spill indicating.

Note further, the following art, referenced by one or more of U.S. Pat. Nos. 10,633,774 B2, 11,103,851 B2 and 11,117,116 B2:

U.S. Pat. No. 4,923,454. This patent, cited in U.S. Pat. Nos. 10,633,774 B2, discloses microfiber-containing absorbent structures and absorbent particles.

U.S. Pat. No. 5,149,335. This patent, referenced in U.S. Pat. Nos. 11,103,851 B2and 11,117,116 B2, discloses an absorbent structure.

U.S. Pat. No. 5,167,764. This patent, referenced in U.S. Pat. Nos. 11,103,851 B2and 11,117,116 B2, discloses a wet laid bonded fibrous web.

U.S. Pat. No. 5,167,765. This patent, referenced in U.S. Pat. Nos. 11,103,851 B2 and 11,117,116 B2, discloses a wet laid bonded fibrous web containing bicomponent fibers including LLDPE.

U.S. Pat. No. 5,476,616. This patent, cited in U.S. Pat. No. 10,633,774 B2, discloses an apparatus and process for uniformly melt-blowing a fiberforming thermoplastic polymer in a spinnerette assembly of multiple rows of spinning orifices.

U.S. Pat. No. 8,017,534 B2. This patent, cited in U.S. Pat. No. 10,633,774 B2, discloses a fibrous nonwoven structure having improved physical characteristics and method of preparing.

Patent Application Publication No. US 2009/0233049 A1. This publication, cited in U.S. Pat. No. 10,633,774 B2, discloses a coform nonwoven web formed from propylene/alpha-olefin meltblown fibers.

It would be desirable to further ameliorate if not substantially or fully solve the problem of sifting particulate absorbents of organics, i.e., organic chemicals and mixtures thereof. It would be desirable to increase the pick-up power of organic spill response products. It would be desirable to provide improved water filtration and pollution prevention products. It would be desirable to provide further improved manufacture yet ameliorate or solve sifting with improved targeting of smaller releases of organic liquids. It would be desirable to provide the art with one or more viable alternative(s) and/or improvements.

### A SUMMARY OF THE INVENTION

In address of the foregoing, provided hereby is an article of manufacture for, and its use in, absorbing an organic chemical or organic chemical mixture comprising a construction of a nonwoven fabric web with a particulate absorbent sensitive to the organic chemical or mixture thereof. The nonwoven fabric web can be melt blown and/or spunbond product(s) or a Spun-Blown® hybrid meltblown-spunbond product as found in U.S. Pat. No. 10,633,774 B2, and it is generally an adsorbent, versus an absorbent, of the organic chemical or mixture thereof. The particulate absorbent is an absorbent as defined by the American Society for Testing & Materials (ASTM) performance standards such as ASTM F-716, F-726 and F-1127. The article can be made using methods found in U.S. Pat. No. 10,633,774 B2 with regard to the disclosures of U.S. Pat. Nos. 11,103,851 B2 and 11,117,116 B2, and used to absorb and hold small volume organic liquid releases, versus those found in large spills.

The invention is useful in organic spill control, remediation, water filtration, etc.

Significantly hereby, the art is advanced in kind, and a viable alternative is provided. Embodiments hereof can further ameliorate if not fully solve the problem of sifting of oil sensitive, particulate absorbents of organics, i.e., organic chemicals and mixtures thereof, to include oil, fuels and solvents, which is very important as it engenders an ability to ascertain how much absorptive capacity an article hereof has or retains, and thus provides for better performance, and more accuracy and precision in use of the present articles. It can improve absorption selectivity in targeting of smaller spills in organic spill response and remediation operations, provide improved water filtration opportunities and pollution prevention products, and provide improved manufacture-all while ameliorating or solving the sifting problem, and accomplishing the same, if necessary or desirable, in an aqueous environment. Thus, present articles can have benefits related to being able to reliably capture, particularly through true absorption or imbibition in contrast to simple, surface-coating adsorption alone, roughly four times or more volumes of target organic compound or mixtures thereof than corresponding nonwovens without the oil sensitive, particulate absorbent of the organic chemical or organic chemical mixture therewith. This can provide for a practical advantage in use as the smaller article generally requires less material and be made in smaller sizes, say, in roughly one foot square pads versus four square foot pads (roughly 0.092903 meters square (m²) versus roughly 0.371612m² ) and can be employed in more confined or cramped spaces while being capable of doing as much or more than a typical nonwoven fabric, can be pleated so as to be placed within a cartridge or housing for enhanced filtration purposes, and provide a competitive advantage as well since it may cost less to make. Articles of the invention are efficient to make and use. Numerous further advantages attend the invention.

### DRAWINGS IN BRIEF

The drawings form part of the specification hereof. With respect to the appended drawings, which are not necessarily drawn to scale, the following is briefly noted:

FIG. 1 is a schematic of an apparatus and method to make an article of manufacture for absorbing or imbibing an organic chemical or organic chemical mixture and comprises a construction of a nonwoven fabric web with an oil sensitive, particulate absorbent of the organic chemical or organic chemical mixture. Compare, U.S. Pat. No. 10,633,774 B2.

FIG. 1A shows employment of an alternative to matter found in circle 1A of FIG. 1.

FIG. 2 is an enlarged vertical cross-section of an article hereof, which can be formed from the apparatus and method of FIG. 1 or FIGS. 1 and 1A, and so forth.

FIG. 3 shows apparatus making articles of manufacture hereof. Compare, FIGS. 1, 1A and 2.

FIG. 4 shows a nonwoven fabric web, a melt-blown polypropylene with a weight of 200-gram per square meter (200 g/m²) areal or surface density, say, as a Spun-Blown® hybrid meltblown-spunbond polypropylene nonwoven fabric web without particulate absorbent of an organic chemical or mixture thereof, and having an oil sensitive indicating dye associated therewith, employed in room temperature laboratory testing. As a control sample, using a tub to hold a liquid organic chemical or mixture of organic chemicals, here, mineral spirits, which may be termed, “solvent,” this nonwoven fabric web is saturated at a 150-mL/ft² (1.615-L/m²) level with respect to the nonwoven component, and lifted up above the solvent surface, which engenders dripping of solvent from the web by gravitational force.

FIGS. 5-8 show tubs holding mineral spirits, and nonwoven fabric webs, each a melt-blown polypropylene with a 200 g/m² or so areal or surface density, say, as a Spun-Blown® hybrid meltblown-spunbond polypropylene nonwoven having an oil sensitive indicating dye associated therewith, and sitting in a tub in contact with the solvent, more particularly with FIG. 5 showing a control in which the web with dye as in FIG. 4 is saturated with mineral spirits when reaching about 150 mL of solvent per square foot of web (about 1.622 L of solvent per square meter of web), and FIG. 6-8 showing embodiments of the invention made from Spun-Blown® hybrid meltblown-spunbond polypropylene nonwoven pads loaded with 150-micron to 400-micron diameter Imbiber Beads® absorbent beads at loading levels of about thirty grams per square foot (about 30 g/ft² (about 323 g/m²)) in FIG. 6; about 56 g/ft² (about 603 g/m²) in FIG. 7; and about 70 g/ft² (about 753 g/m²) in FIG. 8. The fabric webs in FIGS. 6-8 are in contact with an amount of 300-mL/ft² (about 3230-mL/m2) solvent loading.

FIG. 9 shows an embodiment of the invention as found in FIG. 8, at saturation level, lifted above a tub without any release of organic solvent and thus and not dripping.

FIGS. 10-12 show embodiments of the invention as found in FIGS. 6-8, respectively, in increasing amounts of solvent, each resting in a tub that had solvent which was absorbed.

FIG. 13 is a cutaway view of a pleated, nonwoven water filtration device hereof.

### DETAILED DESCRIPTION OF ILLUSTRATIVE EMBODIMENTS

The invention may be further understood by the detail set forth below. As with the foregoing, such detail, which may be read in view of the drawings, generally is to be taken in an illustrative and not necessarily limiting sense.

In general, article of the invention 100 absorbs an organic compound or mixture thereof as liquid 7, and includes nonwoven fabric web 112 with particles 114 in its matrix for such absorption. Note these and other features as found in the drawings:

| Feature(s) | Comment |
|---|---|
| 10, 12, 112 | Method/device 10 to make hybrid nonwoven web 12, |
| | 112 with matrix |
| 14, 114 | Stream of first material 14, 114, generally in a form |
| | of particles |
| 16, 18, 20 | Sheet or mat 16 of first material 14, 114 broken into |
| | particles by fiberizer 18 having discharge nozzle 20 |
| 120, 121 | Funnel system option 120 with adjustable nozzle 121 |
| | for particles 114 |
| 40 (sic 42), 62 | Spun-blown streams 40 (sic 42) and 62 |
| 22 | First polymer resin 22, initially particulate, then |
| | melted, etc. |
| 24, 26, 28 | Hopper 24, conduit 26, extruder 28 for first polymer |
| | resin 22 |
| 30, 32, 34, 36 | Conduit 30 to die block 32 to spinerette 34 with |
| | nozzles 36 |
| 38, 40 | Filaments 38 of first polymer 22 drawn into first |
| | Spun-blown fibers 40 |
| 42 | Pair of cover strips 42 on spinerette 34 to shelter |
| | nozzles 36 from air |
| 44 | Second polymer resin 44, initially particulate, then |
| | melted, etc. |
| 46, 48, 50 | Hopper 46, conduit 48, extruder 50 for second |
| | polymer resin 44 |
| 52, 54, 56, 58 | Conduit 52 to die block 54 to spinerette 56 with |
| | nozzles 58 |
| 60, 62 | Filaments 60 of second polymer 44 drawn into second |
| | Spun-blown fibers 62 |
| 64 and 69 | Cover strip pair 64, 69 on spinerette 56 to shelter |
| | nozzles 58 from air |
| 66, 68, 70 | Forming wire 66, rollers 68, foraminous surface 70 on |
| | forming wire 66 |
| 72, 74, 76 | Vacuum source 72, wind-up spindle 74, web cutter 76 |
| 78, 80, 82 | Top surface 78, bottom surface 80, and middle 82 of |
| | web 12, 112 |
| X-X, Y-Y, T | Longitudinal axis X-X, vertical axis Y-Y, thickness T |
| | of web 12, 112. |

The nonwoven fabric web 112 may be made of any suitable material. For example, it may be or include a polyolefin, say, a polypropylene. Such a web may be a Spun-Blown® hybrid meltblown-spunbond polypropylene as in U.S. Pat. No. 10,633,774 B2. It may have any suitable density. As a pad or other approximately two-dimensional product, which may be folded or pleated as in a form of a filter for a canister, it may have an areal or surface density that may be, independently at each occurrence, a 100 g/m² to 300 g/m², or a 150 g/m² to 250 g/m² or so, say, about 200 g/m² item.

The particulate, oil sensitive absorbent 114 may be made of any suitable material, but beneficially is a fluid-organic-swellable, water-insoluble polymer, which is or had been provided as water insoluble, particulate organic polymeric particles that, when contacted with a substantially hydrophobic fluid organic substance when present, absorb or imbibe said substance and swell substantially thereupon, such as Imbiber Beads® particles, which may be evenly disbursed within the nonwoven fabric web 112 at various weight distributions, dependent upon the desired performance criteria. Advantageously, the fluid is a liquid at room or field temperature. Cross-linked polymers of styrenes or substituted styrenes, notably t-alkyl styrenes, say, t-butyl styrene, or vinyl toluene can be used to advantage as the particulate organic chemical(s) absorbent to imbibe target organic chemical(s). See, U.S. Pat. Nos. 11,103,851 B2 and 11,117,116 B2. See also, U.S. Pat. Nos. 3,322,695; 3,750,688; 4,302,337; 5,149,335; 5,167,764 and 5,167,765 as well as U.S. Pat. Nos. 7,169,318 B1; 7,704,750 B2 and 7,862,779 B2. As is known in the art, a cross-linker may be required to help make the particulate absorbent, and often is employed with high purity reactants such as 99.6% purity t-butyl styrene. High purity reactants, however, typically come at a higher price, to which is added the cost of the cross-linker. It has been found that certain less pure reactants such as vinyl toluene at a lesser grade of purity do not cost as much as higher purity grades and furthermore do not require a cross-linker to make the particulate organic chemical(s) absorbent to imbibe the target organic chemical(s). The particulate absorbent 114 is hydrophobic, and oil sensitive. It may have a swelling index with respect to absorbed organic chemical or mixture of organic chemicals, independently at each occurrence, of at least 1.5 or 3.0, or at least or between 1.5, 3.0 or 5.0, and 10.0, 20.0, 30.0 or 50.0, and so forth and the like, with respect to the target organic chemical(s) and/or mixture(s) thereof; and it may include particles or beads, independently at each occurrence having an about 50-micron to 1000-micron diameter, an about 100-micron to 700-micron diameter, an about 150-micron to about 400-micron diameter, and so forth and the like. It may be present in the non-woven fabric web 112 at any suitable rate, to include as lower or upper limits or an individual loading level an amount about or more closely or even precisely, independently at each occurrence, 1 g, 5 g, 30 g, any amount from about 10 g to 200 g in 5-g increments, thus including 10 g, 15 g, 20 g, 25 g, 40 g, 45 g, 50 g, 60 g, 65 g, 70 g, 75 g and so forth, per square foot (per 0.092903m² ) or greater, which as upper or lower limits can include illustrative ranges about from 1 g to 5 g, 20 g to 200 g, 5 g to 200 g, 10 g, or 25 g to 80 g or 100 g per square foot (per 0.092903m² ), or another value or range.

The articles of the invention 100 can absorb a wide variety of organic compounds or mixtures of organic compounds, particularly when these are put in contact as liquids with the articles. These generally include oleaginous liquids and distilled organic liquids and laboratory and industrial reagents and solvents, more particularly, crude oil, transformer oil, electric motor oil, internal combustion engine oil, 2-cycle oil, outboard engine fogging oil, household oil, mineral solvents (also known as paint thinner and white spirits), cooking oil, home heating oil, diesel fuel, kerosene, jet fuel, gasoline, decane, octane, hexane, toluene, benzene, and so forth and the like.

The articles of the invention 100 may appear in a form of pads of any suitable size or configuration, say, as 9-inch by 1-foot (0.069 -m by 0.093-m) pads, 1-foot by 1-foot (0.093-m by 0.093-m) pads, 1-foot by 1.5-foot (0.093-m by 0.14-m) pads, 2-foot by 2-foot (0.19 -m×0.19-m) pads, and smalller or larger sizes, and in triangular, circular and so forth shapes.

### ILLUSTRATIVE EXAMPLE

For early stage prototypes, a 200 g/m² melt-blown polypropylene (mb-pp) was considered for use as the nonwoven fabric best representing a standard commercial product.

Three different volumes of Imbiber Beads® product 114 made from alkyl styrenic monomer and having about from 150-micron to 400-micron particulate diameters would be added directly into the mb-pp web, with note of disclosures in U.S. Pat. No. 10,633,774B2, through a gravity-feed funnel system 120 having an aperture 121 that can be adjusted so as to accommodate the desired volume of Imbiber Beads® product 114 added per area square unit.

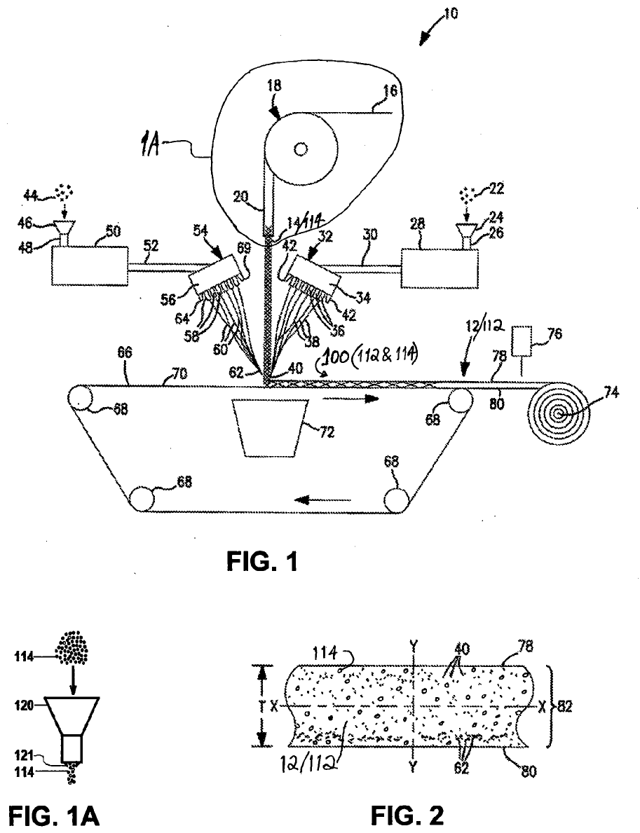

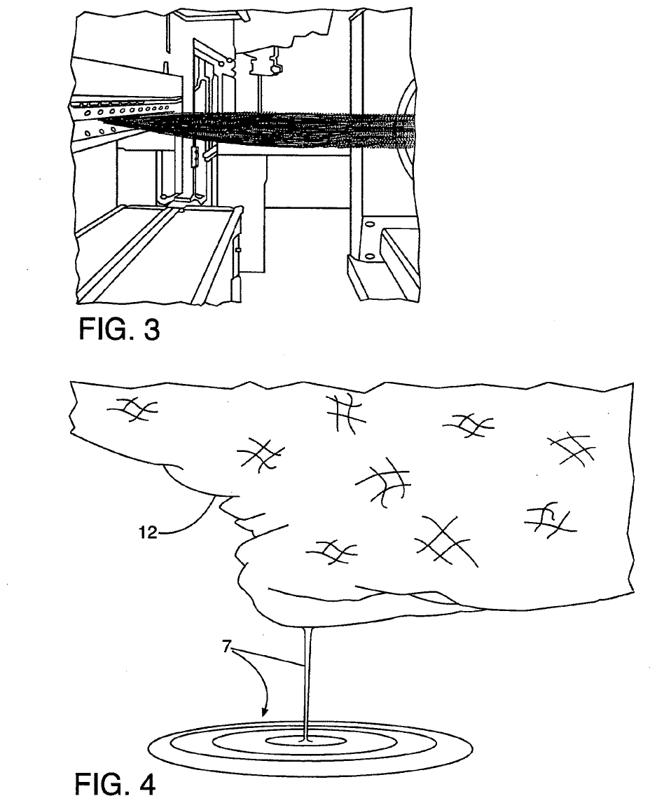

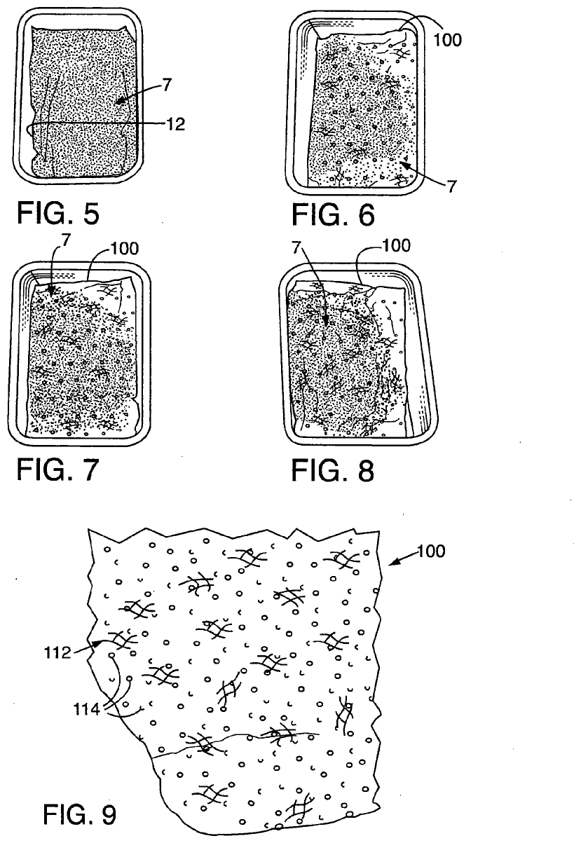

Similarly, by adjusting the speed of the web uptake, it was also possible to increase or decrease the volume of Imbiber Beads® particles 114 introduced into the nonwoven fabric web 112 per area square unit. To reinforce the retention of Imbiber Beads® absorbent particles 114 into the nonwoven fabric web 112 and to contribute to a more uniform appearance, calendar bonding was employed, which also helped to evenly segment the Imbiber Beads® particulate absorbent 114 throughout the matrix of the nonwoven web 112. The absorbent beads 114 remain intact in the matrix of the web 112. Note, FIG. 1 et seq.

Early performance trials were conducted to see what improvement might be attainable with a presence of Imbiber Beads® absorbent 114 in the nowoven fabric web 112.

The maximum test liquid 7 that the control samples 12 could adsorb was recorded as 150 mL/ft². For the tests, the nonwoven fabric webs 12, 112 of all samples were 9 -inch by 12-inch (22.9-cm by 30.5-cm) size pads. Mineral spirits as the test liquid 7 represent an effectiveness of the Imbiber Beads® beads 114 on diesel and jet fuel, JP8. An oil-sensitive dye is added, which may be a red dye such as Oil Red “A” (Solvent Red 24) and so forth and the like, noting, for example, U.S. Pat. No. 7,704,750 B2.

Typically, sorption ratios will remain constant for all samples, regardless of their size.

Upon retrieval, gravitational pull caused the control samples 12 to release an amount of their liquid contents 7 within a 30-second drip time. See, FIG. 4. Based on initial observation, it is understood that, given enough drip time, the majority of the adsorbed liquid contents 7 would have been released. The liquid 7 is held within interstitial space between matted fibers, classic adsorption, and as such is still available as a liquid in discrete droplets.

By comparison, all of the samples with Imbiber Beads& bead product 114 easily held the test liquid 7 with no liquid available for re-release. See, FIGS. 6-8 and 9, each article of the invention 100 holding 150 ml of the test liquid, and showing succesively increasing absorption capacity available from FIG. 6 to FIG. 8. The “imbibition” process involves the integration of the liquid 7 into Imbiber Beads® particles 114, which have a solid polymer body matrix, evidenced by these polymeric beads 114 “swelling” 2-3 times their original diameters (8-27 times original volumes). This results in complete elimination of free liquid.

Accordingly, the volume of test liquid was increased in increments of 50 mL, in order to determine maximum sorption capacity without release evident, even with gravitational pull. The maximum sorption determinations are as follows (noting that 1 ft²=0.092903m²):

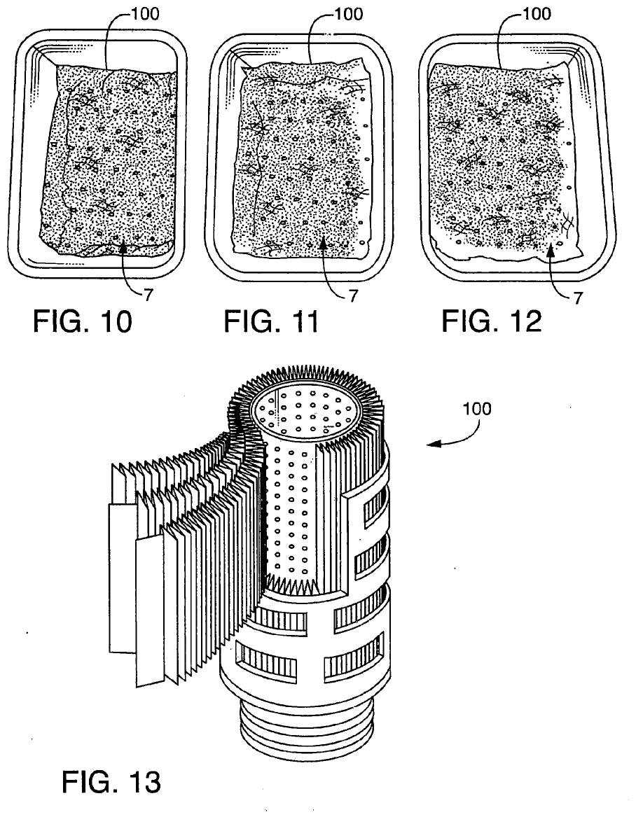

FIG. 10: 500 mL solvent in pad with 30 g/ft² absorbent beads=333% improvement.

FIG. 11: 600 mL solvent in pad with 56 g/ft² absorbent beads=400% improvement.

FIG. 12: 700 mL solvent in pad with 70 g/ft² absorbent beads=467% improvement. No sifting of the absorbent beads 114 from the nonwoven fabric web 112 was observed.

### DISCUSSION

Sizeable opportunities are believed to lie within all identified applications, including:
Oil and chemical spill response—increased efficacy and improved occupational health and safety considerations.
Pollution prevention—award-winning, gravity-flow Drain Protection Systems keep contaminants out of the environment.
Water filtration—the ability to selectively remove organic contaminants from stormwater, produced water and process water is complimentary to many filtration methodologies.

In sum, the addition of an oil-sensitive, super-absorbent polymer such as Imbiber Beads® product gives the non-wovens industry a most notable opportunity to greatly enhance the performance of its existing product lines. The inclusion of a particulate organic chemical absorbent, for example, the Imbiber Beads® product, remedies a number of occupational safety, health and environmental issues that current adsorbent products cannot address. It also supplies the first significant innovation to the industry in the past 50-60 years. In a manner analogous to what took place with the advent of “water-sensitive” super absorbent polymers (SAPs) in the personal hygiene industry, such a particulate organic chemical absorbent provides the opportunity to revolutionize the environmental industry.

### EPILOGUE

From the foregoing, among other embodiments, the following are noted:
A. An article of manufacture for absorbing a substance of an organic chemical or organic chemical mixture, which comprises a construction of a nonwoven fabric web with an oil sensitive, particulate absorbent of said substance, wherein the oil sensitive, particulate absorbent is retained within the nonwoven fabric web essentially without sifting therefrom.
B. The article of embodiment A, wherein the oil sensitive, particulate absorbent is or had been provided as hydrophobic, water insoluble, oil sensitive, particulate organic polymeric particles that, when contacted with a substantially hydrophobic fluid organic substance when present, absorb or imbibe said substance and swell substantially thereupon.
C, D. The article of embodiment A or B, wherein the nonwoven fabric web is a melt blown product, a spunbond product, or a hybrid meltblown-spunbond product.
E, F. The article of embodiment C or D, wherein the nonwoven fabric web is a hybrid meltblown-spunbond product containing a web matrix of polypropylene.
G, H, I. The article of embodiment B, D or F, wherein the oil sensitive, particulate absorbent is made with a styrene or substituted styrene.
J. An article of manufacture for absorbing a substance of a substantially hydrophobic fluid organic chemical or organic chemical mixture, which comprises the following:
   a hybrid nonwoven fabric web including a first material; and a second material defined by spun-blown fibers, which are defined by a thermoplastic composition that contains at least one polymer having a melt flow rate between about 5 grams per 10 minutes to about 500 grams per 10 minutes at 230°, have an average fiber diameter (AFD) between about 1 micron and 10 microns, and define a standard deviation of fiber of fiber diameter with a magnitude that is at least 50% of AFD; and
   as the first material, an oil sensitive, particulate absorbent of said substance, which is or had been provided as hydrophobic, water insoluble, oil sensitive, polymeric organic particles that, when contacted with said substance, absorb or imbibe said substance and swell substantially thereupon.
K. The article of embodiment J, wherein the oil sensitive, particulate absorbent is retained within the nonwoven fabric web essentially without sifting therefrom.
L, M. The article of embodiment J or K, wherein the nonwoven fabric web is made with a polypropylene, and the oil sensitive, particulate absorbent is made with a styrene or substituted styrene.
N. An article of manufacture for absorbing a substance of an organic chemical or organic chemical mixture, which comprises the following:
a hybrid nonwoven fabric web including a fiber matrix having comingled fibers of multiple materials, including a first material; and at least a second material defined by first and second spun-blown fibers, each of the first and second spun-blown fibers being formed from a thermoplastic composition that contains at least one polymer having a melt flow rate from between about 5 grams per 10 minutes to about 6,000 grams per 10 minutes at 230° C., an average fiber diameter between about 1 micron and 10 microns, and a standard deviation of fiber diameter between about 0.9 micron to about 5 microns, wherein the hybrid nonwoven web has a tensile strength of at least about 5 gf/gsm/cm width measured in a machine direction, and the nonwoven web defines an average pore size of less than 30 microns; and
as the first material, an oil sensitive, particulate absorbent of said substance, which is or had been provided as hydrophobic, water insoluble, particulate organic polymeric particles that, when contacted with said substance, absorb or imbibe said substance and swell substantially thereupon.
O. The article of embodiment N, wherein the oil sensitive, particulate absorbent is retained within the nonwoven web essentially without sifting therefrom.
P, Q. The article of embodiment N or O, wherein the nonwoven web is made with a polypropylene, and the particulate absorbent is made with a styrene or substituted styrene.
R, S, T. The article of embodiment A, J or N, wherein a dye is provided with the article to indicate a presence of the organic chemical or mixture of organic chemicals.

In addition, embodiments with other limitations are extant.

As well, methods of using the foregoing article of manufacture embodiments are apparent. In general, they require providing the article of manufacture, and placing it in a location in which an organic chemical or organic chemical mixture may come into contact with it such that should the article come into contact with the organic chemical or organic chemical mixture, the organic chemical or organic chemical mixture is picked up or held through absorption thereof.

### CONCLUSION TO THE INVENTION

The present invention is thus provided. Various feature(s), part(s), step(s), subcombination(s) and/or combination(s) can be employed with or without reference to, or order of, other feature(s), part(s), step(s), subcombination(s) and/or combination(s) in the practice of the invention, and numerous and sundry adaptations and modifications can be effected within its spirit, the literal claim scope of which is particularly pointed out by the following claims:

1. An article of manufacture for absorbing a substance of an organic chemical or organic chemical mixture, which comprises a construction of a nonwoven fabric web with an oil sensitive, particulate absorbent of said substance, wherein the oil sensitive, particulate absorbent is retained within the nonwoven fabric web essentially without sifting therefrom.

2. The article of claim 1, wherein the oil sensitive, particulate absorbent is or had been provided as hydrophobic, water insoluble, oil sensitive, particulate organic polymeric particles that, when contacted with a substantially hydrophobic fluid organic substance when present, absorb or imbibe said substance and swell substantially thereupon.

3. The article of claim 1, wherein the nonwoven fabric web is a melt blown product, a spunbond product, or a hybrid meltblown-spunbond product.

4. The article of claim 2, wherein the nonwoven fabric web is a melt blown product, a spunbond product, or a hybrid meltblown-spunbond product.

5. The article of claim 3, wherein the nonwoven fabric web is a hybrid meltblown-spunbond product containing a web matrix of polypropylene.

6. The article of claim 4, wherein the nonwoven fabric web is a hybrid meltblown-spunbond product containing a web matrix of polypropylene.

7. The article of claim 2, wherein the oil sensitive, particulate absorbent is made with a styrene or substituted styrene.

8. The article of claim 4, wherein the oil sensitive, particulate absorbent is made with a styrene or substituted styrene.

9. The article of claim 6, wherein the particulate absorbent is made with a styrene or substituted styrene, and is present at an amount of about from 20 g to 100 g per square foot of the nonwoven fabric web.

10. The article of claim 1, wherein a dye is provided with the article to indicate a presence of said substance.

11. An article of manufacture for absorbing a substance of a substantially hydrophobic fluid organic chemical or organic chemical mixture, which comprises the following:
a hybrid nonwoven fabric web including a first material; and a second material defined by spun-blown fibers, which are defined by a thermoplastic composition that contains at least one polymer having a melt flow rate between about 5 grams per 10 minutes to about 500 grams per 10 minutes at 230°, have an average fiber diameter (AFD) between about 1 micron and 10 microns, and define a standard deviation of fiber of fiber diameter with a magnitude that is at least 50% of AFD; and
as the first material, an oil sensitive, particulate absorbent of said substance, which is or had been provided as hydrophobic, water insoluble, oil sensitive, polymeric organic particles that, when contacted with said substance, absorb or imbibe said substance and swell substantially thereupon.

12. The article of claim 11, wherein the oil sensitive, particulate absorbent is retained within the nonwoven fabric web essentially without sifting therefrom.

13. The article of claim 11, wherein the nonwoven fabric web is made with a polypropylene, and the oil sensitive, particulate absorbent is made with a styrene or substituted styrene.

14. The article of claim 12, wherein the nonwoven fabric web is made with a polypropylene, and the particulate absorbent is made with a styrene or substituted styrene, and is present at an amount of 10 g to 100 g per square foot of the nonwoven fabric web.

15. The article of claim 11, wherein a dye is provided with the article to indicate a presence of said substance.

16. An article of manufacture for absorbing an organic chemical or organic chemical mixture comprising the following:
a hybrid nonwoven web including a fiber matrix having comingled fibers of multiple materials, including a first material; and at least a second material defined by first and second spun-blown fibers, each of the first and second spun-blown fibers being formed from a thermoplastic composition that contains at least on polymer having a melt flow rate from between about 5 grams per 10 minutes to about 6,000 grams per 10 minutes at 230° C., an average fiber diameter between about 1 micron and 10 microns, and a standard deviation of fiber diameter between about 0.9 micron to about 5 microns, wherein the hybrid nonwoven web has a tensile strength of at least about 5 gf/gsm/cm width measured in a machine direction, and the nonwoven web defines an average pore size of less than 30 microns; and
a particulate absorbent of an organic chemical or organic chemical mixture, which is or had been provided as hydrophobic, water insoluble, particulate organic polymeric particles that, when contacted with a substantially hydrophobic fluid organic substance when present, absorb or imbibe said substance and swell substantially thereupon.

17. The article of claim 16, wherein the particulate absorbent is retained within the nonwoven web essentially without sifting therefrom.

18. The article of claim 16, wherein the nonwoven fabric web is made with a polypropylene, and the oil sensitive, particulate absorbent is made with a styrene or substituted styrene.

19. The article of claim 17, wherein the nonwoven fabric web is made with a polypropylene, and the particulate absorbent is made with a styrene or substituted styrene, which is present at an amount of 5 g to 200 g per square foot (per of the nonwoven fabric web.

20. The article of claim 16, wherein a dye is provided with the article to indicate a presence of said substance.
